(19) United States
(12) Patent Application Publication
(10) Pub. No.: US 2026/0162035 A1
(43) Pub. Date: Jun. 11, 2026

(54) ORCHESTRATOR-BASED RESEARCH AND DEVELOPMENT SYSTEM, AND METHOD FOR OPERATING SAME

(71) Applicant: Forschungszentrum Jülich GmbH, Jülich (DE)

(72) Inventors: Kourosh Malek, Jülich (DE); Michael Eikerling, Köln (DE); Titichai Navessin, Vancouver (CA); Max Dreger, Köln (DE)

(21) Appl. No.: 19/126,826

(22) PCT Filed: Nov. 2, 2023
(86) PCT No.: PCT/EP2023/080571

§ 371 Date: May 2, 2025

(30) Foreign Application Priority Data
Nov. 4, 2022 (DE) 10 2022 211 634.8

(51) Int. Cl. G06Q 10/0631

(52) U.S. Cl. CPC G06Q 10/06316

(57) ABSTRACT

The invention relates to a research and development system (100) suitable for researching and/or developing products and manufacturing methods for products, in particular energy materials, which comprises a database (110) and an interface (120) for inputting and outputting data, a data processing unit (130) and an execution unit (140).

### TECHNICAL FIELD

The present invention relates to a research and development system for researching and/or developing products and manufacturing (production) methods for products, in particular energy materials. It comprises a graph database, a data processing unit and an execution unit. The system is configured to connect work steps of a research and development project in an optimized workflow, to work with heterogeneous systems and to store heterogeneous result data in a consolidated manner and according to a common ontology. The invention also relates to a method for operating a research and development system according to the invention.

The invention relates to research and development system for researching and/or developing (R&D) products and methods for manufacturing products, in particular energy materials and their integration. The invention also relates to a method for operating an R&D system according to the invention.

### BACKGROUND AND STATE OF THE ART

Today's systems and methods for supporting research and development of products and methods for manufacturing products, in particular energy materials, require a high time and personnel expenditure, are prone to errors and malfunctions, and often deliver suboptimal results.

### OBJECTIVE OF THE INVENTION

The task of the invention is therefore to provide an improved research and development system and a method for operating a research and development system for researching and/or developing products and methods for manufacturing products, in particular energy materials.

### DESCRIPTION

This task is solved by a research and development system for research and/or development according to claim 1 and a method for operating a research and development system according to claim 8. Preferred configurations of the present invention are described in the dependent claims. The preferred configurations help to provide an improved research and development system and an improved method for operating it.

The research and development system according to the invention is suitable for researching and/or developing products and manufacturing methods for products, in particular energy materials. It comprises a database, an interface for inputting and outputting data, a data processing unit and an execution unit. The database is a graph database that is configured to store data according to a data model that maps a well-defined ontology.

The data processing unit may be configured to unify (standardize), supplement, and/or enrich the data stored in the graph database. In addition, the data processing unit can be configured to identify statistical and/or causal relationships between data in the database and to model these relationships using statistical models and/or physico-chemical models. Furthermore, the data processing unit can be configured to identify research and development goals in the stored data and/or to generate and/or adapt suitable workflows and/or work steps to achieve research and development goals.

In this case, the execution unit can be configured to select a workflow to achieve a development goal as a function of the development goal. In addition, the execution unit can be configured to select a next work step from a set of work steps of a selected workflow, in particular as a function of a preceding work step and/or a result of a preceding work step.

In one implementation, the execution unit can be configured to select a terminal (terminal device) for performing a work step, in particular as a function of the type, scope and/or time of the work step to be performed and/or the type, scope, time and/or status of the fulfillment of the conditions of availability of the terminal.

In a further embodiment, the research and development system may comprise a data acquisition unit. The data acquisition unit may be configured to localize, capture and/or store in the graph database information relevant for a selected research goal, in particular specialist articles, publications, test series, lectures, comments and/or other relevant records and/or documentation. The data acquisition unit can further be configured to localize a result of an implementation of a work step by a terminal, to capture it, to label it with respect to formation and origin and/or to store it in the graph database.

In one implementation, the data acquisition unit can be configured to capture information on a type, scope and/or time of availability and/or non-availability of a terminal and/or store it in the graph database. In addition, the data acquisition unit can be configured to capture information on technical, administrative, legal, contractual and/or other conditions of the availability of a terminal and on the status of fulfillment of the conditions of availability and/or store it in the graph database.

In one implementation, the research and development system comprises an interactive human-machine interface. This can be configured to graphically display results of a work step and/or the work steps of a workflow and/or to display a workflow, a work step, the availability of a terminal for performing a work step. Likewise, the interactive human-machine interface can be configured to receive input from a human user for selecting a workflow to be performed, a work step to be performed and/or a terminal for performing a work step.

In one implementation, the research and development system comprises a server, a cloud system, a terminal, an edge computing unit and/or a fog computing unit. In a preferred embodiment, the server, the cloud system, the terminal, the edge computing unit and/or the fog computing unit are IoT-capable.

In one implementation, the graph database, the data processing unit, the execution unit, the data acquisition unit, the edge computing unit, the fog computing unit and/or the interactive human-machine interface are configured to use methods of artificial intelligence (AI), in particular machine learning (ML) and/or deep learning (DL), and/or to provide results in real time.

The method for operating a configuration of the research and development system according to the invention can comprise one or more of the following steps a) to k). In a preferred configuration, these steps are carried out using methods of artificial intelligence and/or in real time.

Storing data in a graph database according to a data model that represents a well-defined ontology;
unifying, supplementing, and/or enriching data stored in the graph database;
identifying statistical and/or causal relationships between data stored in the graph database and/or modeling these relationships using statistical models and/or physico-chemical models;
identifying research and development goals included in the stored data and/or generating workflows and/or work steps suitable for achieving the research and development goals;
selecting a workflow for achieving a development goal as a function of the development goal and/or selecting a work step from a set of work steps of a selected workflow, in particular as a function of a preceding work step and/or a result of a preceding work step;
selecting a terminal for performing a work step, in particular as a function of the type, scope and/or time of the work step to be performed and/or the type, scope, time and/or status of the fulfillment of the conditions of availability of the terminal;
analyzing a result of a work step by an edge computing unit and/or a fog computing unit and/or forwarding the analysis result as the result of the work step;
capturing, labelling with respect to formation and origin and/or storing in the graph database a result of a work step;
localizing, capturing and/or storing in the graph database information relevant to a research goal, in particular specialist articles, publications, test series, lectures, comments and/or other relevant records and/or documentation;
localizing, capturing and/or storing information in the graph database on the type, scope, time of availability and/or non-availability of a terminal, on technical, administrative, legal, contractual and/or other conditions of the availability of a terminal and/or on the status of fulfillment of the conditions of availability;
graphically displaying a result of a work step, several work steps of a workflow, a workflow, a work step and/or the availability of a terminal for performing a work step; and/or
receiving a selection from a human user of a workflow or work step to be performed and/or a terminal for performing a work step.

The method according to the invention and/or individual steps of the method according to the invention can be implemented as a computer program product. The computer program product can execute the method and/or individual steps of the method when it is executed by a suitable computing unit. Such a computer program product can be stored on a storage medium and/or installed, stored and/or provided for download on a computing unit, such as a server or cloud system.

### SHORT DESCRIPTION OF THE FIGURES

For a better understanding of the features and advantages of the invention, some embodiments of the invention will be described in more detail below with reference to the attached FIGS. 1 to 14. However, the illustrations in the Figures only serve to illustrate some embodiments and should not be regarded as restrictive, as there may be other equally effective embodiments.

FIG. 1 shows a schematic overview of an implementation of a research and development system according to the invention.

FIGS. 2 and 3 show an example of a sequence of steps in the method according to the invention for designing, initializing and continuously using a research and development system according to the invention.

FIG. 4 shows a simplified representation of the ontology for European Materials Modeling (EMMO).

FIG. 5 shows a simplified example of an ontology according to the invention.

FIG. 6 shows main advantages of a cross-departmental and/or cross-user ontology according to the invention.

FIG. 7 shows the main components of the Resource Description Framework (RDF) concept, which can be used in a configuration according to the invention, for example in the field of integrating materials into components for H₂ technologies.

FIG. 8 shows an example of the integration of a graph database into a research and development system according to the invention, with a focus on the decentralization of terminals and a very heterogeneous data structure with complex data pipelines.

FIG. 9 shows an example of the import of raw data in tabular form, e.g. as an .out file, according to the invention.

FIG. 10 shows an example of a representation of imported raw data as a graph according to the invention.

FIG. 11 shows an example of a top-level visualization of a manufacturing process based on measurement data and simulation data according to the invention.

FIG. 11 shows a simplified representation of a data infrastructure according to the invention and procedure for training machine learning models and their application.

FIG. 12 shows a simplified, schematic representation of an example of a according to the invention.

FIG. 13 shows a schematic example of the use of statistical and causal models according to the invention.

FIG. 14 shows a process and an architecture.

### DETAILED DESCRIPTION

Today's scientific research and development (R&D), particularly in the field of energy materials, requires a high level of effort and highly qualified personnel. The technical and organizational infrastructures, in particular systems, devices and processes, are very heterogeneous, are managed and operated decentrally and without sufficient connectivity, and are standardized to a limited extent only. This has a negative impact on the efficiency and quality of research and development.

In order to solve these deficits, an improved research and development system 100 for the development of products and manufacturing methods of products, in particular energy materials, up to device integration, is proposed. This research and development system 100 helps in particular to ensure data connectivity between decentralized data and terminal nodes and to optimize research and development processes.

Research and/or development is understood to mean all planned and/or systematic activities based on scientific methods with the aim of acquiring new knowledge. In this context, “new” is to be understood in relation to the respective organizational unit performing the research and/or development.

A research and development system refers to a system for supporting research and/or development activities. Products refer to objects that comprise a tangible component.

The research and development system 100 according to the invention can also be referred to as an orchestrator. An orchestrator refers to a hardware-based and software-based unit for the automated management of tasks on one or more devices. An orchestrator can orchestrate the performance of tasks, i.e. connect and/or automate them in a coherent workflow, in order to achieve a predetermined goal. In particular, this may include providing access to devices and automatically starting the execution of tasks on devices, booking or assigning capacities, working with heterogeneous systems and/or performing a deployment in different geographical locations and with different device operators. In addition, orchestration can include the execution of other administrative and control functions, such as authorization monitoring and/or policy enforcement when using a device.

A distinction must be made between orchestration and mere automation. Automation is a subfield of orchestration. Automation focuses on making a task quickly repeatable with little or no manual intervention. Orchestration enables coordination between and across many automated activities and takes the environment into account.

A workflow refers to a process, in particular for the research and development of a product or a manufacturing method, that is made up of individual parallel and/or sequential work steps and/or activities. The workflow describes the operational-technical view of the work steps and/or activities to be carried out. Ideally, this description is so exact that the following work step or activity is determined by the outcome of the preceding one(s). The individual work steps and/or activities are therefore dependent from each other. A workflow comprises a plurality of interrelated work steps. A workflow has a defined beginning, an organized flow, and a defined end. Workflows are characterized by a coordinative nature. These are to be distinguished from cooperative systems, in which the synchronous, strictly separate execution of steps and/or activities is in the foreground.

A work step comprises an activity or set of activities that are directed towards achieving a given research and/or development goal. The activities of a work step and their execution can be meaningfully separated from other activities. However, the activities of the same work step and their performance cannot be meaningfully separated or can only be meaningfully separated with difficulty due to their internal structure and/or dependencies on each other. In particular, work steps can be experiments, tests, measurements, observations and/or the mechanical, physical and/or chemical modification of material objects and/or substances or materials.

Energy materials comprise, in particular, materials that are essential for technologies for scalable energy conversion and/or energy storage in or from electrical energy, e.g. for fuel cells, water or CO₂ electrolysis, photovoltaics and/or rechargeable batteries or primary batteries.

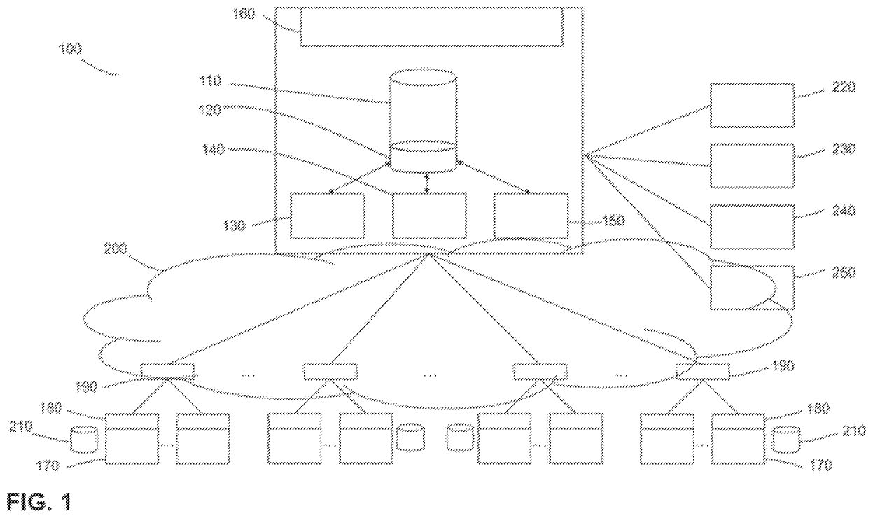

FIG. 1 shows a schematic overview of an implementation of a research and development system 100 according to the invention. It comprises a database 110 with an interface 120 for inputting and outputting data, a data processing unit 130 and an execution unit 140. The database comprises a graph database 110 that is configured to store data according to a data model which represents a well-defined ontology 16. Ontology refers to a fixed set of classes, rules and restrictions for the formal description of knowledge.

Data processing unit refers to a unit for the electronic evaluation and processing of electronically stored data, in particular for the recognition of connections, similarities, patterns, dependencies and/or redundancies of the classification, assignment and/or derivation of models, prognoses, concepts and plans.

Execution unit refers to a unit for selecting and performing a workflow, work step and/or activity to achieve a goal, as well as for selecting and/or starting a terminal 170, in particular a time, a location and/or an organizational unit for performing a workflow, work step and/or an activity.

Furthermore, the research and development system 100 according to the invention can comprise a data acquisition unit 150 and/or an interactive, preferably graphical, human-machine interface 160. The data acquisition unit 150 can be configured to localize, to capture and/or to store in the graph database 110 information relevant to a research goal and/or research area, such as specialist articles, publications, test series, lectures, comments and/or documentation. Such information may, for example, be stored electronically in a decentralized manner on a publication server 220, in a research database 230 or on websites 240. This information can, for example, be localized using crawlers and, if necessary, evaluated and captured using text mining methods. Similarly, information may not be available in electronic form. This could, for example, be captured electronically using scanners 250.

Interactive human-machine interface refers to an input/output unit that makes it possible to exchange information, data and/or commands between a human user and a data processing system. An interactive graphical human-machine interface 160 refers to the output of information and/or the option to input information, data and/or commands that are adapted to the human perception and/or can be understood and/or learned particularly quickly and easily by a human user. Such an interface may comprise a dashboard, i.e. a graphical user interface used to visualize data and/or operating elements.

Data acquisition unit refers to a unit for manual and/or electronic, automated identification and/or capturing of analog and/or electronic, structured and/or unstructured data. Manual capturing can, for example, comprise the input by a human user via keyboard, voice, camera or scanner. Automated capturing in this context refers in particular to capturing by means of machine-to-machine communication, for example by means of a crawler or a text-mining unit.

(Software) programs that are also called bots or spiders are referred to as crawlers. These search communication networks, in particular the internet, in an automated manner. To do this, a crawler successively processes predefined tasks, e.g. a number of addresses in the net that are to be visited. The content stored at the address is searched and checked, for example, for the presence of predefined, relevant content and/or copied for storage in a database. Likewise, a crawler can follow links found at one address to other addresses in order to continue or expand the search for relevant content.

Text mining refers to algorithm-based analysis methods for discovering structures of meaning from unstructured and/or weakly structured text data. Text mining usually proceeds in several steps. First, suitable data material is collected, for example with the help of a crawler specialized in relevant topics. In a second step, this data is prepared, for example including automatic and/or optical text recognition and/or character recognition, so that it can be analyzed in the following using text mining methods. Text-mining methods involve statistical and linguistic means that allow structures and data to be derived from texts, which can be captured and stored in a database, ideally in an automated manner. At the very least, however, text-mining methods should enable a human user to quickly identify key information in the processed texts. Ideally, text-mining methods provide information of which human users do not know beforehand if and that it had been included in the processed texts. When used in a targeted manner, text-mining tools are also able to generate hypotheses, test them and gradually refine them.

The research and development system 100 can comprise a terminal 170 for carrying out a research activity. The terminal 170 can be communicatively connected to the database 110 and/or the interface 120, the execution unit 140 and/or the data acquisition unit 150.

The communicative connection 200 can, for example, be established via the internet and/or a specialized, non-public communication network for voice and/or data.

A terminal refers to a system, instrument, computer, other device and a method performed on a terminal for performing a work step or an activity. A terminal 170 may, for example, be a high-performance computer, a self-driving lab or laboratory (SDL), a high throughput screening (HTS), a potentiometer, a porosimeter, a viscometer, an imaging method, a mathematical, numerical or theoretical analysis model, or a computational and atomistic-meso-scale simulation method. Terminals generate an enormous amount of data, such as simulation and calculation data, imaging data from transmission electron microscopy (TEM), imaging data from scanning electron microscopy (SEM), electroanalytical measurement data such as impedance, power curves and any other form of current-voltage or material characterization data.

In one implementation, the data acquisition unit 150 is configured to capture a result of an implementation of a work step by a terminal 170, to label the result with respect to its formation and origin, and/or to store it in the graph database 110. To reduce the data to be communicated, the research and development system 100 can comprise an edge computing unit 180 and/or a fog computing unit 190.

An edge system or a fog system refers to intermediate layers between a core data center, in particular a server or a cloud computing system, and terminals 170 connected via a network infrastructure. These intermediate layers comprise analysis units, so-called edge computing units 180 and/or fog computing units 190, which are located at or near the respective terminals 170. As a rule, fog computing units 190 are located between the edge computing units 180 and the central units. These edge/fog computing units 180, 190 analyze the large amount of raw data from the terminals 170 and only forward the results and/or findings derived from it to the core data center, e.g. the server or the cloud. The original raw data is discarded. An edge/fog system thus shifts data processing to the “edge”, the edge and/or “fog between the edge and the cloud” of the network, thus helping to minimize latency and prevent bottlenecks in data transmission over the net.

Furthermore, the data acquisition unit 150 can be configured to localize, capture and/or store in the graph database 110 information on the type, scope or time of availability and/or non-availability of a terminal 170 or any other relevant resource. In addition, the data acquisition unit 150 can be configured to locate, capture and/or store in the graph database 110 information on technical, administrative, legal, contractual and/or other conditions of availability and/or on the status of fulfillment of the conditions of availability of a terminal 170 or other resource. Such information may in particular be stored in decentralized research facilities, for example in local file systems or databases 210.

The data processing unit 130 can be configured to supplement, unify and/or enrich the data stored in the graph database 110. Furthermore, the data processing unit 130 can be configured to identify statistical or causal relationships between the data in the database 110 and to model these relationships using statistical models and physico-chemical models. In addition, the data processing unit 130 can be configured to identify research and development goals in the stored data and to generate suitable workflows and/or work steps to achieve these goals based on the identified goals and relationships between the data, and/or to adapt existing workflows and/or work steps based on additional data.

The execution unit 140 can be configured to select a workflow for achieving a development goal and/or a next work step of a workflow. In particular, the selection can be made as a function of a development goal or a preceding work step and/or its result.

Furthermore, the execution unit 140 can be configured to select a terminal 170 for performing a work step or activity. The selection can be made as a function of the type, scope and/or time of the work step/activity to be performed, as well as the type, scope, time or status of the fulfillment of the conditions of the availability of the terminal 170.

The interactive human-machine interface 160 can be configured to graphically display a work step or work steps of a workflow and/or their results. Likewise, the interface 160 can be configured to display the availability of a terminal 170 and/or any other relevant resource. The interactive human-machine interface 160 can also be configured to receive an input from a human user for selecting a research goal, a workflow or work step to be performed or a terminal 170 for performing a work step or activity.

In one implementation, the units, devices and systems comprised by the research and development system 100 according to the invention can be IoT-capable. In addition, the units, devices and systems can be configured to provide and/or communicate results in real time and to execute artificial intelligence (AI) methods, in particular machine learning (ML) and/or deep learning (DL).

IoT stands for “Internet of Things”. The “Internet of Things” refers to the linking of uniquely identifiable physical objects (or “things”) with an electronic interface and virtual representation in a (global) Internet-like infrastructure. This comprises communication protocols optimized for machine-to-machine communication. This enables not only human-to-human communication, but also human-to-object and object-to-object communication. The objects of the Internet of Things are thus given the opportunity to organize themselves, exchange information and interact with each other. Human intervention remains possible in principle, but is no longer absolutely necessary.

Artificial intelligence (AI) refers to the ability of a technical system to exhibit human-like, intelligent capabilities, such as logical thinking, learning, planning, creativity, seeing, hearing and/or understanding.

Machine learning (ML) refers to the ability of a technical system to generate knowledge from experience. Deep learning (DL) refers to a method of machine learning that uses artificial neural networks (ANN) with numerous intermediate layers (“hidden layers”) between the input layer and the output layer, thus developing an extensive internal structure. Such an artificial system learns from examples and can generalize them after a learning phase. Different methods can be used for this, for example, supervised learning, unsupervised learning, reinforcement learning and deep/multilayer learning.

In this context, real time refers to an operation in which the processing results are available within a predetermined, in particular guaranteed, period of time, in particular in which the data processing and/or communication takes place almost simultaneously, preferably simultaneously, with corresponding processes in reality.

Furthermore, the research and development system 100 can comprise a server and/or cloud system. In particular, the database 110, the data processing unit 130, the execution unit 140 and the data acquisition unit 150 can be installed and operated on a (central) server and/or in a cloud system.

A server refers to a computing unit that performs certain tasks for other systems connected to it in a network and on which these may depend, either in whole or in part. A server helps to integrate, manage and control a plurality of devices, in particular, including different devices and/or devices at different geographical locations, in the research and development system in an improved manner.

A cloud computing system is a system that is built according to the cloud computing model. Cloud computing describes a model that provides shared computing resources quickly and with little effort, such as servers, data storage, and applications (“Apps”), as a service on demand, in particular via the internet, independently of the device, and bills according to use. The provision and use of these computer resources is defined and usually takes place via an application programming interface (API) and/or, for users, via a website or app. Characteristic features of a cloud computing system are, for example, on-demand self-service, broad network access based on standards for different devices, resource bundling, rapid elasticity in line with demand, and continuous performance measurement to optimize and control the cloud system.

In particular, the research and development system 100 according to the invention enables networking, coordination and interaction of various terminals 170 and actors. This results in particular in rapid retrievability, rapid availability and traceability of the result data and thus in an improved R&D management of decentralized, heterogeneous R&D units.

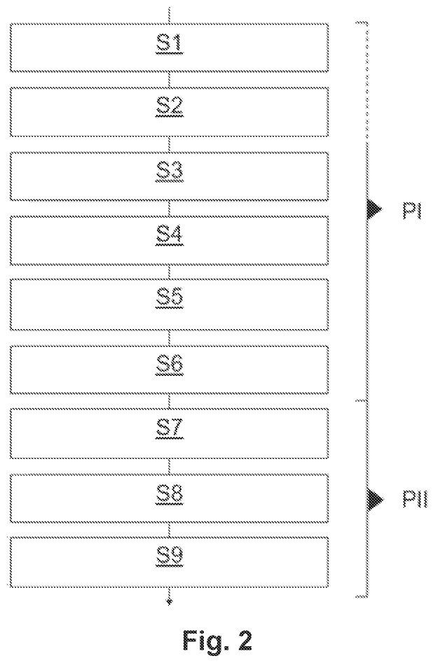

To provide a better understanding of the features and advantages of the method according to the invention, FIGS. 2 and 3 show an example of a sequence of steps of the method according to the invention for designing, initializing and continuously using a research and development system 100 according to the invention to support research and development projects. The steps and sequences shown represent only one exemplary configuration of the method according to the invention and are not to be understood restrictively.

The steps S1 to S9 in FIG. 2 have the following meaning:
S1: Defining ontology and data model;
S2: Designing the graph database;
S3: Localizing and capturing information and data relevant to a research area and/or research goal;
S4: Importing/storing the captured information in graph database according to the structure of the interfaces and/or the data model;
S5: Creating a training data set; training a model for supplementing, unification; enrichment of the data;
S6: Supplementing, unifying, enriching data in graph database using (AI) models;
S7: Identifying relationships; creating statistical data models; assigning physico-chemical models;
S8: identifying research goals in data; generating work steps and workflows to achieve research goals;
S9: localizing and capturing information on the availability of terminals, instruments, systems and/or other resources;
wherein PI: Phase I and PII: Phase II.

The steps S10 to S21 in FIG. 3 have the following meaning:
S10: Selecting a research goal; selecting a workflow to achieve the research goal;
S11: Determining a next work step from workflow;
S11a, S11b: Was the step from S11 successful?—if yes, then continue with S11a; if no, then continue with S11b;
S12: Select/start a terminal to perform a work step/activity; if necessary, labeling for tracking;
S13: Perform the work step/activity via the terminal; send the result to edge unit;
S14: Evaluate raw data from the terminal; send the result to the fog unit;
S15: Evaluate the results from edge unit; transmit the result to capturing unit;
S16: Capturing and storing the results of a work step/activity; if necessary, if necessary, labeling for tracking;
S17: If necessary, supplement, unify, enrich the result data (see S6);
S18: Characterization of the result data (see S7): creation/assignment of statistical data models; assignment of physico-chemical models;
S19: Generation/adaptation of a new work step and/or workflow to achieve the research goal (see S8);
S20: Manual intervention to generate/select a next work step;
S20a/ S20b: Was the step from S20 successful?—if yes, then continue with S20a; if no, then continue with S20b;
S21: research goal achieved? Termination and/or discontinuation;
wherein PIII: Phase III.

### Capturing Unit

With today's research and development approaches, three phases can usually be distinguished: In the first phase, relevant data sources for the respective topic or objective are to be identified, articles are to be reviewed, and data is to be collected and consolidated (see FIG. 2, Phase I). This first phase alone can take several days or several weeks. In the second phase, phase II, after the data acquisition and preparation, the data is analyzed in consultation with the respective R&D team and/or expert, a summary of the competition comparison is created and a decision is made on the next action steps. The practical research and development work only begins in the subsequent third phase, phase III. The objectives of this practical research and development work may include, in particular, the manufacturing (production) of new substances, materials and prototypes. To achieve this, it is usually necessary to perform experiments, measurements and simulations, as well as to analyze, model and validate the observed results and relationships.

This practical research and development work in the third phase, Phase III, requires access to highly specialized instruments and devices, which are also interchangeably referred to here as terminals. These are often located in different facilities, both inside and outside a research organization. Thus, contracts must be concluded and workflows for samples and results must be coordinated. This is usually done manually and in one-on-one discussions with the individual institutions. This process is inefficient and subject to numerous uncertainties, for example due to differences in test protocols, instrument integrity and/or different skills and approaches of the performing persons. This alone leads to a high degree of variability.

In particular, when cross-departmental, cross-organizational and/or cross-location research and development facilities are involved, the data generated is often very heterogeneous. For example, different application systems and/or users generate very different types of data, such as data from experiments, simulation data or data from scientific literature, such as journals, conferences, blogs and online databases.

Furthermore, different domains and sub-domains use their own specialized vocabulary. This specialized vocabulary differs at least slightly or partially from the vocabulary and/or semantics of other domains or sub-domains. Likewise, a variety of different units of measurement and/or reference points are used depending on the domain, sub-domain and/or data source.

Furthermore, the data and their data formats, classifications and value ranges can refer to different levels of analysis or abstraction, for example, to the macro, meso and micro levels. Macro, meso and micro levels refer to different levels of analysis and/or abstraction. At the macro level, large aggregates and/or systems are examined. At the meso level, the focus is on parts and components of these aggregates or systems. At the micro level, individual elements and/or the interactions between individual elements are considered.

In addition, data management, i.e. the processing and administration of research data and research results from different sources, is also carried out in a non-uniform, non-standardized way. Rarely does the quality of data management meet the requirements of a professional organization with well-defined, standardized and comparable data structures and formats. This makes it more difficult, and in practice often impossible, to use the results of other units in an ongoing research project and to reuse results of other areas of preceding research by other areas, in related fields or in the context of subsequent research projects.

In order to be able to use these very large, very heterogeneous data volumes efficiently and effectively in the preparation phases of a research project, Phase I and Phase II, as well as during the performance of the practical research work, Phase III, the data are stored in a common database 110 in a suitable, unified data structure and a suitable, common data model.

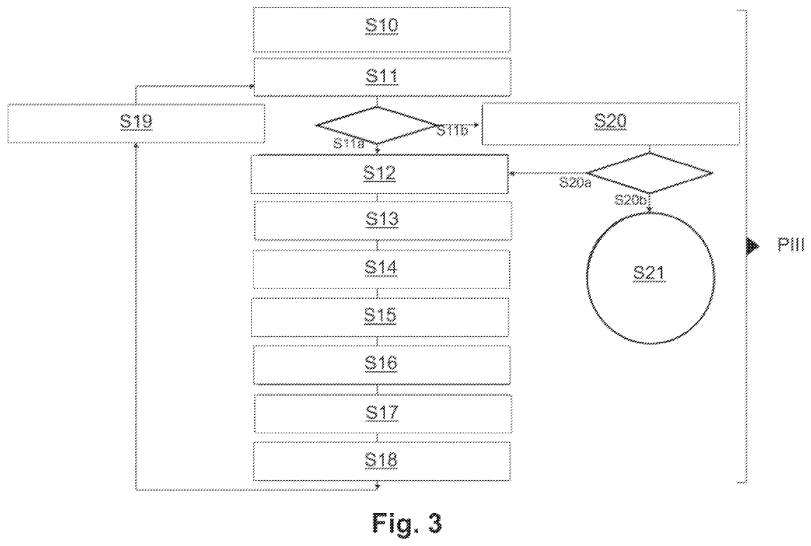

To make this possible, a well-defined ontology 16 is selected and/or defined in a first step S1, as shown in FIG. 2, and the data model of the database 110 according to the invention is defined on this basis. In one configuration, for example, the European ontology of materials modeling EMMO of the European Materials Modeling Council EMMC shown in FIG. 4 can be used for this purpose.

The ontology 16 EMMO 1 shown in FIG. 4 comprises classes with attributes and relationships that may have a direction. Examples of types of relationships are ‘isA’ 2, ‘hasMember’ 3, ‘hasPart’ 4, ‘hasTemporalPart’ 5. Further rules and constraints can be introduced for the classes and relationships. An example of a relationship is <Collection-Class>‘—has a relationship with—’<Item-Class>. An example of a rule and/or constraint is that each instance of a <Collection-Class> must have at least two ‘hasMember’ relationships to different instances of the <Item-Class>.

Instances denote concrete objects of an ontology. They are created using previously defined classes, e.g., ‘Berlin’, ‘London’, ‘Paris’, ‘Rome’ would be different instances of the ‘type city’ of a class ‘topological location’.

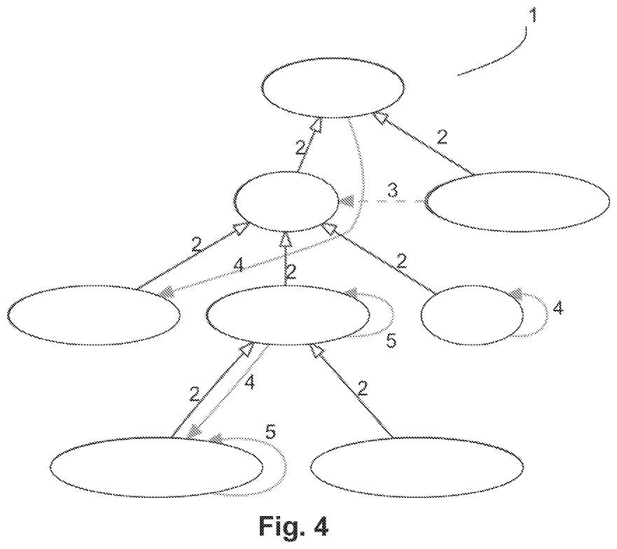

FIG. 5 shows an implementation of an ontology 16 according to the invention. The classes and properties of the configuration of an ontology 16 according to the invention shown in FIG. 5 are based on the basic approach and framework concept of the European ontology for materials modeling EMMO 1. Such an ontology 16 according to the invention can be extended to different and/or related R&D areas and, in particular, enables interoperability with other EMMO-based platforms. In the implementation shown in FIG. 5, the ontology according to the invention comprises the objects “Matter/Material/Component” 6, “Process” 7, “Measurement” 8, “Property” 9 and “Metadata” 10 as well as the properties “processed” 11, “manufacturing” 12, “has participant” 13, “has part” 4, “measured” 14, “obtained amount” 15.

In this, classes and class properties are branched into class hierarchies to describe the specific materials, components, properties and processes of an R&D area. These specialized hierarchies are further refined by rules and constraints that are also area-specific. This makes it possible to provide a resilient, powerful framework for the formalized, structured representation and storage of knowledge.

Such an ontology 16 can be used to design the data model of a database 110 according to the invention. In such a case, the ontology 16 makes it possible to define the properties of the data model and thus also the structure of the interfaces 120. Thus, the ontology 16 helps to design a database 110 according to the invention, which provides clearly defined input/output interfaces 120 at the application level and thus enables efficient data storage and access to otherwise heterogeneous application data.

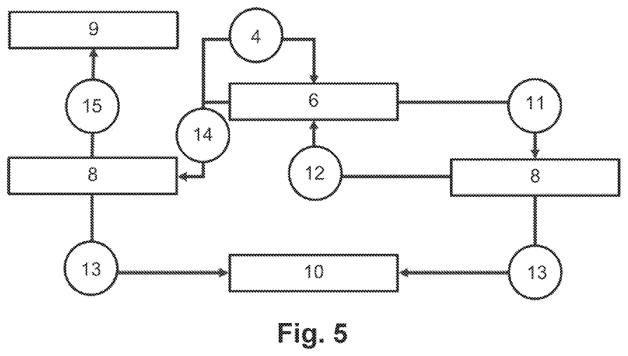

The most important advantages of the use and/or provision of data in a common ontology 16 according to the invention are shown in FIG. 6. In particular, the use of a common, well-defined ontology 16 allows finding and accessing data from different data sources 170, 220, 230, 240, 250. Likewise, the exchange and further use of data between different R&D units 18 is possible. Likewise, once developed results and data that once have been generated can be reused in the context of further R&D projects or subsequent steps. Whereas, in the absence of such a unified ontology 16, results and data generally cannot be interpreted and understood objectively. In this case, results and data are ultimately to be evaluated as respectively subjective data with little use for achieving research and development goals.

A data model that is suitable for an ontology 16 and graph database 110 according to the invention can, for example, be constructed according to the Resource Description Framework (RDF) for the standardization of data models. A data model for a graph database constructed according to this framework concept is particularly suitable for making information interchangeable between different applications and readable by machines.

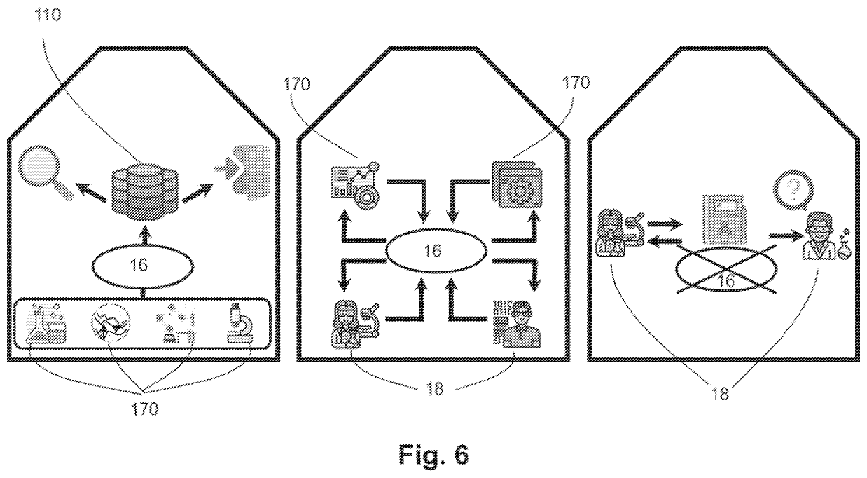

As shown in FIG. 7, a graph database designed according to the resource description framework RDF is constructed using so-called RDF expressions. An RDF expression is a triple consisting of subject 22, predicate 23 and object 24. The subject 22 is the resource, e.g. catalyst ink, that is described. The predicate 23 is a property, e.g. processed, of a resource to be described. The object 24 is the specific value of this property, e.g. a uniquely identified processing step. Each triple 21 thus represents a logical statement regarding a relationship between the subject 22 and the object 24. Several of these RDF expressions 21 form a coherent RDF graph, which can be viewed as a semantic network.

Subjects 22 and objects 24 are represented as nodes 25 and predicates 23 as edges in the graph database 110. Edges 26 connect two nodes 25, respectively, and thus represent relationships. Edges 26 can have properties and a direction. An edge 26 must have a type. Nodes 25 are instances of associated classes and can have any number of properties. In addition, nodes 25 can have any number of “designations” 27. Designations 27 group nodes into sets, such as materials 6 and processes 7. In particular, in the case of a large graph database 110, edges 26 of a node 25 can be stored in an adjacency list. In an adjacency list, all edges 26 emanating from a node 25 are stored. Unlike in a matrix structure, for example, it is therefore not necessary to query entire rows and/or entire columns in order to identify all neighboring nodes of a node 26.

As shown in FIG. 2, in a second step S2, a graph database 110 according to the invention is designed on the basis of the ontology 16 and the data model. A graph database is a database that is based on graph theory. It consists of a set of objects that can be nodes or edges. Nodes represent objects that may be tangible, intangible, concrete and/or abstract. Edges connect nodes to other nodes and represent the relationship between them. Graph databases may, for example, be constructed according to the concept of the so-called Labeled Property Graph (LPG) or the so-called Resource Description Framework (RDF). Accessing nodes and edges in a (native) graph database according to the invention is an efficient operation with constant runtime and makes it possible to quickly traverse millions or an extremely large number of edges per second. Regardless of the total size of the data set, graph databases are particularly suitable for processing highly interconnected data and complex queries.

In view of the requirements of the system 100 according to the invention, the use of a graph database is advantageous as opposed to a relational database as an alternative solution. The system 100 according to the invention is confronted with highly heterogeneous data. While the data structure of a relational database is rigid, the data structure of a graph database is highly flexible. For the system 100 according to the invention, the recognition of correlations and/or direct and indirect relationships is important. While it is difficult to express indirect relationships within a relational database, the representation of relationships and chains of relationships is the essential feature of a graph database. The system according to the invention 100 is to be able to identify/predict correlations, direct and indirect relationships, as well as similarities. While this is only possible with a relational database using special, AI-based approaches, it is also possible with a graph database using classical and/or graph-based approaches. The ability to visualize data is essential for the system according to the invention. While separate visualization tools have to be used for this with a relational database, the data structure of a graph database already includes the visualization of data and its relationships.

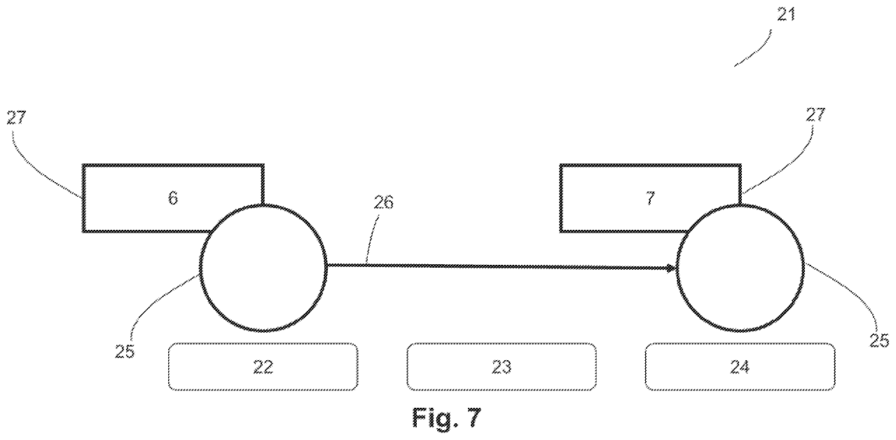

As shown in FIG. 8, the concrete implementation in the second step S2 of a graph database 110 according to the invention can be carried out with the help of program tools such as Neo4j, Neomodel 20a and Cypher 20b. Neo4j is an open-source graph database implemented in Java, version 1.0 of which was released in February 2010. Neomodel 20a is an object graph mapper OGM for Neo4j graph databases 110. An object graph mapper OGM maps nodes and relationships of a graph to objects and references in a specific data model. Object instances are mapped to nodes, while object references are mapped to properties using relationships and/or series. Cypher 20b is an open-source graph query language for Neo4j-based graph databases. The Cypher open-source project provides all the specifications needed to create efficient queries to create, read, update or delete a graph without specialized knowledge of the specific storage form.

In a third step S3, the information and data relevant to a research area or a specific research goal are localized and captured by the data acquisition unit 150. An example of a research area and a research question is, for example, the effect of solvents on the manufacturing of catalyst layers for PE fuel cells. Information and data can be localized in an automated or semi-automated manner using a suitably configured data acquisition unit 150, for example with the help of crawlers. In doing so, potentially relevant (historical) information, in particular specialist articles, publications, test series, lectures, comments and/or other relevant records of experiments and/or documentation are localized. In addition, the relevance of the content is checked and, if necessary, the content is extracted, for example, using text-mining methods in the case of less structured text data. In this way, all external/published and internal/unpublished experimental data, modeling data and raw data on a research area and/or question can be collected and classified, for example, on the basis of manufacturing steps.

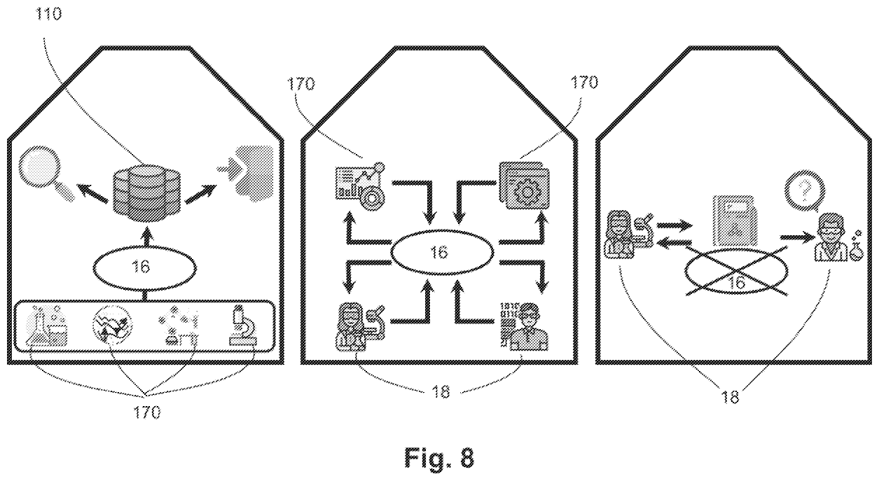

In a fourth step S4, the data and information captured by the data acquisition unit 150 can be imported and stored in a graph database 110 according to the invention. This data may comprise, for example, measurement data and simulation data from experiments and manufacturing processes. FIG. 9 shows an example of an import of raw data in tabular form into a graph database 110. In the example of FIG. 9, the rows of one of the tables represent a fuel cell manufacturing, for example characterized by a manufacturing identification number 19. The columns represent the parameters 19a and materials 6 of the fuel cell manufacturing. To import the raw data, an appropriate understanding of the manufacturing process is required so that the contents of the table can be recognized and assigned to the interfaces 120 or the data model of the graph database 110. Alternatively, suitably configured, easy-to-understand interfaces 120 can be used, such as electronic laboratory notebooks (ELN) interfaces or appropriately specified .out files 120a. Likewise, it is possible to provide users with a suitable, clearly understandable structure for entering data using application programming interfaces (APIs) 120b, as shown in FIG. 8, for example. Such capturing and storage of data in a graph database 110 according to the invention enables data and information to be found quickly, traced, and used uniformly and effectively by a network of interconnected instrument and computer data centers and various operators and actors.

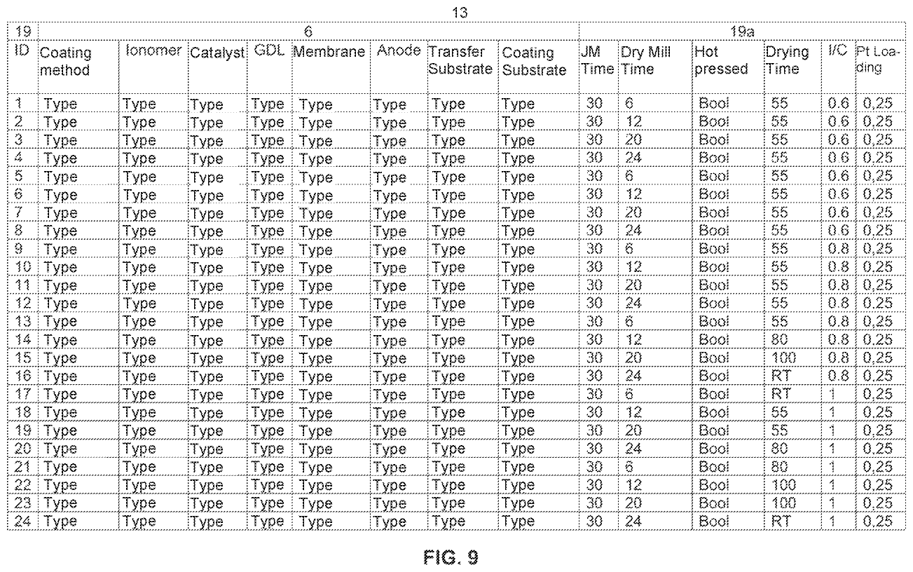

FIG. 10 shows an example of the visualization of the manufacturing of a fuel cell based on the data stored in a graph database 110. Storing as a graph makes it possible to map and display all parameters 19a and used materials 6, manufacturing stages 6a, as well as all relationships between materials 6, manufacturing stages 6a and parameters 19a up to the final product 6b of the manufacturing process. In addition, an ontology 16 according to the invention and the graph database 110 data model based on it enable the manufacturing process to be displayed, including the characterization and/or measurement 8 of properties 9. This illustrates that the resulting model is very flexible, since the number of processing steps and parameters is not defined. The rules and restrictions of the ontology 16 and the resulting data model ensure that only meaningful relationships are introduced between nodes. The ontology 16 underlying the data model helps to extend the data model if necessary, to adapt further data models suitably and/or to unify them.

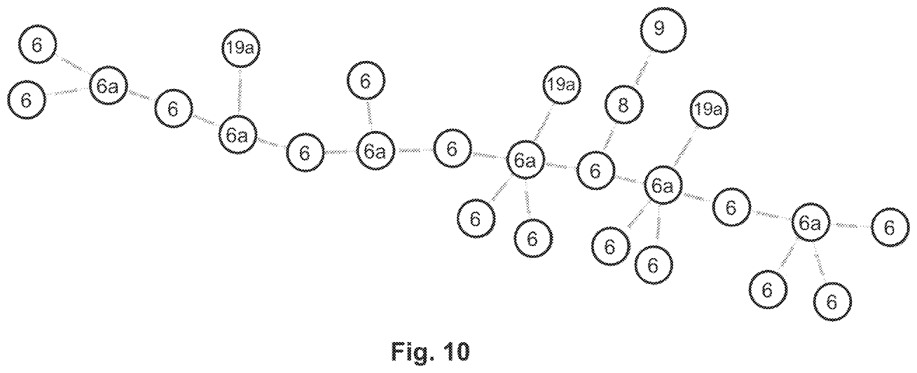

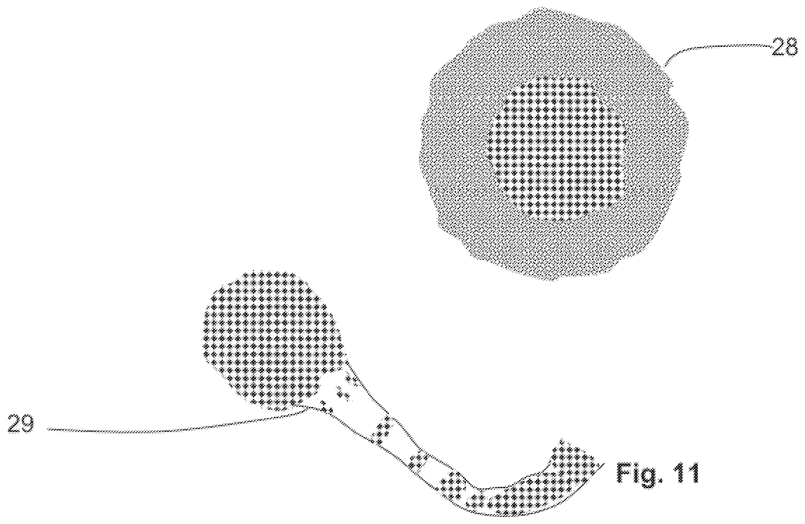

In addition, the processing of the data according to the invention enables a simple, meaningful visualization. FIG. 11 shows an example of a visualization of a fuel cell manufacturing process 29, which comprises the process from the starting materials to the finished fuel cell, as well as measurements on the fuel cell. On the other hand, a visualization of a simulation 28 is shown.

In a fifth and sixth step S5, S6 (see FIG. 2), the data stored in the graph database 110 can be supplemented, unified, and enriched. For example, this can be done on the basis of suitable regression methods and/or pattern-matching methods.

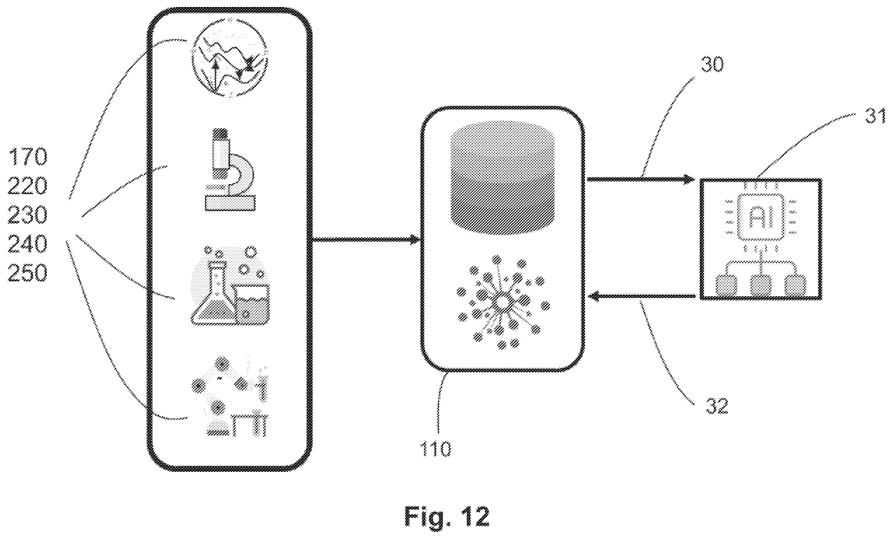

In a fifth step, S5, training data sets 30 (see FIG. 12) are preferably compiled and/or generated on the basis of the data sets stored in the graph database 110. Using these training data sets, a suitable algorithm that can be executed by the data processing unit 130, in particular an artificial intelligence AI 31, such as a machine learning model ML and a deep learning model DL, for example, can be trained. Such an AI 31 can be trained, for example, using the generated training data set 30 and unsupervised learning. In this process, the model reflects overarching knowledge. Further refinements and improvements for more specific tasks and/or partial data sets can be made, in particular by adjusting the weights of the trained AI model. Subsequently, in a sixth step S6, the trained AI can be applied to the other data sets in the database 110 to complete, unify and enrich the contents, formats, attributes, identifiers of the data.

Collecting a large amount of data on the physico-chemical properties of catalyst materials in a database 110 can serve as an example of the fifth and sixth steps, S5, S6 (see FIG. 2). The collected data sets may include, for example, conductivity, electrical properties, current and voltage. For some materials, the database may lack 110 entries for Faraday efficiency, and/or this data may not have been captured or measured. In such a case, the AI/ML algorithm can determine correlations from the complete entries (in real time) to derive the relationship between voltage and Faraday efficiency. This auto-correlation function can then be used to predict and supplement the Faraday efficiency for the data sets and/or materials for which it is missing. This makes the data sets/data more comparable and easier to analyze. This helps to perform analyses across different data sources 170, 220, 230, 240, 250 (see FIG. 12) and to identify and model overarching correlations, relationships and structures in the otherwise incomplete and/or heterogeneous data.

In the third phase, Phase III, researchers, particularly in the field of fuel cells, electrolysers and batteries, are confronted with very complex systems, instruments and terminals in their practical work. This complexity leads to a high-dimensional parameter space. Therefore, data-driven models are a promising approach for deciding on research work and planning it in the second phase, Phase II, and for accelerating and optimizing workflows in the performance of practical research and development work in the third phase, Phase III. For example, data-driven models can be placed in self-controlling laboratories 170 to create feedback loops that enable iterative optimization of the manufacturing process and/or to find new materials.

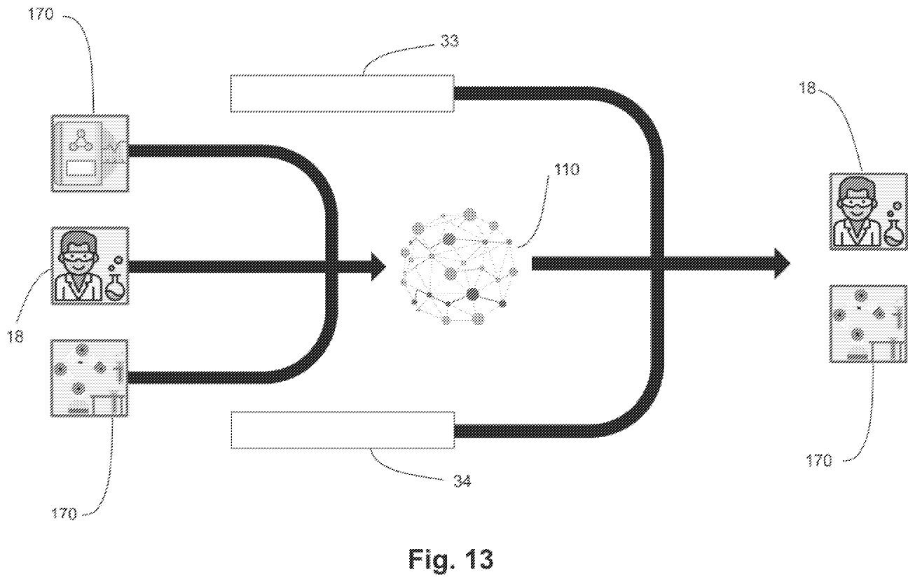

In order to generate data-driven models for optimized planning and performance of research work, in a seventh step S7 (see FIG. 2) the data processing unit 130 can be used to identify statistical and causal relationships between the data in the database 110 and to generate statistical models 33 for modeling these relationships or to assign known statistical models 33 and/or physico-chemical models 34 (see FIG. 13). In one implementation, this can be done using methods of artificial intelligence AI, for example machine learning ML or deep learning DL.

As shown in FIG. 2, in an eighth step S8, using the data processing unit 130 and based on the data that may have been completed, unified and enriched in the preceding steps S5, S6, and/or the statistical and causal, physico-chemical relationships identified and modeled in the preceding step S7, research goals can be identified, for example, the manufacturing of certain materials and/or their device integration. In addition, the work steps and activities relevant to achieving the goal, along with their mutual dependencies, can be identified in the data. In particular, also the work steps and activities that are not required to achieve the goal using the identified statistical and causal relationships. On this basis, optimized workflows can be identified and/or generated. This can also be done, for example, using methods of artificial intelligence AI, in particular machine learning ML or deep learning DL.

As mentioned above, the practical work in the third phase, phase III, usually requires access to highly specialized instruments and devices, which may also be located outside the organization conducting the research. In a ninth step S9 (see FIG. 2), information on the availability of terminals, instruments, systems and/or other resources 170 can be localized, captured and stored in the graph database 110, for example by means of the data acquisition unit 150. Such information and data can, for example, be stored on networked terminals 170 and/or administrative units 210 assigned to them, such as databases, PCs, servers. For example, the physico-chemical data for all catalyst materials used in hydrogen manufacturing can be stored in a so-called data lake. In this way, internal and/or external employees can be restricted to accessing all or some of the materials stored in the data lake, and/or the conditions of access can be defined, communicated and managed. Localization, capturing and storage in the graph database 110 helps to make planning in the second phase, Phase II, and later use in the third phase, Phase III, efficient and preferably automated. The stored information can be used for both the research project currently being performed and for further, subsequent research projects.

In a tenth step S10 (see FIG. 3), a suitable workflow can be selected for achieving the research goal corresponding to the selected research goal. This step S10 can preferably be carried out in an automated manner by the execution unit 140. In the following step S11, the next work step to be executed is selected. If the next work step could be successfully determined, the execution unit 140 can select a terminal 170 in the following step S12 to perform the work step or an activity of the work step, and in a preferred implementation start if for execution. The selection of the terminal 170 can be made as a function of the type, scope and/or time of the work step to be carried out, as well as the type, scope, time and/or status of the fulfillment of the conditions of availability of the terminal 170.

In addition, a label for terminal 170 and the work step performed can be generated when selecting S12 terminal 170. Such a label can also be captured and stored by data acquisition unit 150 in a later step (see S16) when capturing the result data. This makes it possible to clearly identify the origin and type of the data formation. Such a label can be, for example, a unique coding in the form of an alphanumeric code, a bar code or a QR code. Likewise, such a label, for example in the case of physical materials to be shipped, can comprise an embedded memory chip and a simple execution function to ensure data quality and data curation. The execution function can be based, for example, on a simple AI algorithm embedded in the memory chip.

In the following step S13, the selected terminal 170 can perform the selected work step or activity. As explained above, terminals 170 can generate a very large amount of raw data as a result. Therefore, the raw data can be analyzed and processed in the subsequent steps S14, S15 in assigned edge/fog units 180, 190. The raw data/input data is discarded after the analysis is complete and only the result data is forwarded. This helps to use the capacity of the communication network 200 efficiently and to avoid bottlenecks and delays. It also helps to filter out noise from the raw data in an improved manner before it is transmitted to the data acquisition unit 150 and captured and stored in a structured manner by the data acquisition unit 150 in the next step S16.

In the subsequent step S17, the data can be completed, unified and enriched by the data processing unit 130, comparable to the sixth step S6 already described. Likewise, the data for evaluating the results of a work step, for example the results of an experiment, of a manufacturing, of a simulation or of a measurement, can be validated, justified and/or checked for plausibility and characterized by the data processing unit 130. To do this, and comparable to the seventh step S7 described above, relationships can be identified, statistically modeled 33 or assigned to statistical models 33 and/or causal models 34 (see FIG. 13).

It is not always possible for the selected workflow to anticipate and/or comprise all potential results and the conclusions and work steps to be derived from them. This can result in increased effort, increased time, less than optimal decisions and/or less than optimal research and development results. Therefore, in a subsequent step S19, comparable to the previously described eighth step S8, each executed work step and workflow can be analyzed and the analysis results can be used, for example in a pre-trained AI algorithm 31, to suggest and/or generate new work steps and/or workflows for the next execution. In this way, new work steps and/or workflows can be proposed with each iteration.

After that, step S11 can be performed again to determine the next work step. In this, the selection of the next work step can depend on the preceding work step and/or the result of the preceding work step. For example, the process of manufacturing a catalyst layer consists of selecting the precursor materials, such as solvent, catalyst, ionomer medium, followed by specific mixing conditions, such as pH and temperature, and finally a specific characterization before the coating process. Accordingly, for a given target, such as manufacturing a catalyst layer, a specific, optimized workflow can be selected and the work steps of the entire manufacturing process can be automatically selected and executed on this basis. In this, the relevant data pipelines, i.e., the communication channels 200 for transmitting the relevant measurement data and results from the executing terminals 170, can be automatically retrieved for each step of the manufacturing process and included in the selected workflows.

If a next work step can be determined in an automated manner by the execution unit 140 S11a, a new cycle S12-S19 of selecting a terminal 170, performing a work step and evaluating the results begins. If a work step cannot be determined in an automated manner by the execution unit 140 S11b, the generation and/or determination of a next work step can be performed manually by a researching person in a further step S20 S20a and a cycle S12-S19 can be performed again. For such a manual intervention, in this step S20 contents and relationships of the data stored in the graph database 110 can be visualized by means of the interactive human-machine interface 160 and selections and inputs can be captured. If it is not possible to manually generate and select a next step S20b, this may mean that the research goal has been achieved and/or the research project has been terminated (prematurely) S21.

The visualizations described, as exemplified in FIGS. 10 and 11, and the possibility of manual intervention can also be provided in the other steps described. According to the invention, different data centers or instrumental measurements 170 in the decentralized measurement centers can be linked and mapped by different operators or players 18. This enables research experts to make a timely and efficient (preliminary) assessment of the data and results.

The possibility of visualization and manual intervention does not conflict with (IoT-based) machine-to-machine communication between the units of the research and development system according to the invention.

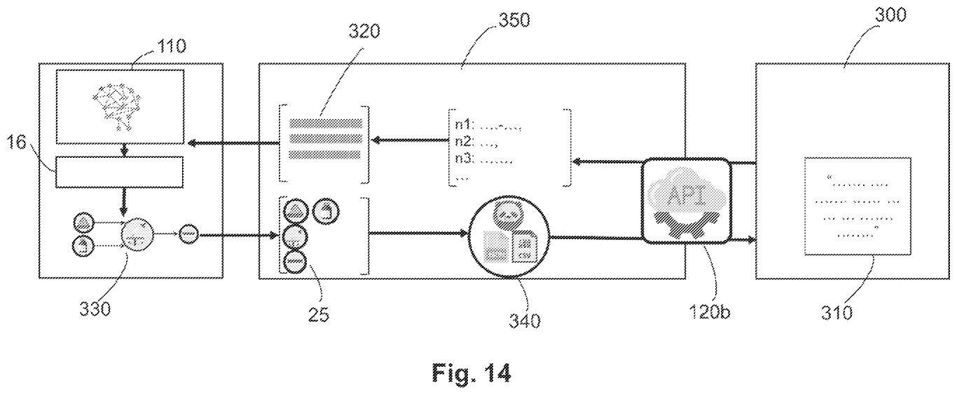

FIG. 14 shows a process and an architecture of an exemplary embodiment comprising a semantic search using a large language model (LLM).

A data model and an ontology 16 which are used to label data sets are crucial components of a semantic search pipeline that uses large language models 350. LLMs 350 are used to generate descriptions and alternative designations for ontology classes. These names and descriptions are used to generate embeddings 320, that is, vector representations of human language. The generated embeddings 320 are linked to the ontology classes in the database 110.

When querying a database 110, for example for a manufacturing process, a user 300 must describe the structure of the desired process as a search query 310, such as materials, intermediates, products, parameters, properties and manufacturing steps. For each part of the search query 310, an embedding 320 is generated which is passed to the database 110 to find the closest embedding 320 in the set of ontology embeddings. The resulting matches are checked to see if there are patterns 330 among them that match the described process or sub-process. The matching patterns and/or node patterns 330 are retrieved, the data stored in the nodes 25 is parsed and converted into a predefined output structure 340, such as a table or JSON format.

JSON (JavaScript Object Notation) refers to a standardized text-based format for representing structured data based on JavaScript object syntax.

In another exemplary embodiment, the data transfer is carried out in an automated manner. In this process, technical table data is read (semi-)automatically by a pipeline, independently of the structure, terminology or size of a table. To start a transformation process for automatic data transfer, the table is parsed and a dictionary with the headings, some example lines and a character string that provides additional context is generated and forwarded to the pipeline. The pipeline consists of a series of LLM instances that are linked to solve the following tasks:
Task 1, mapping a column of a table to a node label of a database 110,
Task 2, identifying node attributes found in headers and cells of a column,
Task 3, combining columns that need to be mapped to the same node, such as column 1 with heading MaterialA_name and column 2 with MaterialA_ID, which include two attributes of the same node, and
Task 4, deriving relationships, i.e., semantic links between nodes extracted from columns.

The (semi-)automatic data transfer is crucial because material science data assets are often in small, isolated tables and steps to automate their inclusion are needed to create powerful training data sets. In addition, the pipeline enriches and maintains the data by mapping the terminology in the table to the ontology 16, which increases interoperability. Furthermore, the pipeline promotes the interconnection of data, which makes it more valuable because it enables the creation of very specific training data sets.

1. A research and development system suitable for researching and/or developing products and manufacturing methods for products, in particular energy materials, which comprises a database and an interface for inputting and outputting data, a data processing unit and an execution unit,
wherein the database is a graph database configured to store data according to a data model that maps a well-defined ontology;
wherein the data processing unit is configured to
unify, supplement, and/or enrich the data stored in the graph database,
identify statistical and/or causal relationships between data in the database and model these relationships by means of statistical models and/or physico-chemical models and/or
identify research and development goals in the stored data and/or generate and/or adapt suitable workflows and/or work steps to achieve research and development goals;
wherein the execution unit is configured to
select a workflow for achieving a development goal as a function of the development goal and/or
select a next work step from a set of work steps of a selected workflow, in particular as a function of a preceding work step and/or a result of a preceding work step.

2. The research and development system of claim 1, wherein the execution unit is configured to select a terminal for performing a work step.

3. The research and development system of claim 2, wherein the research and development system comprises a data acquisition unit which is configured to
localize, capture and/or store in the graph database information relevant to a selected research goal, in particular specialist articles, publications, test series, lectures, comments and/or other relevant records and/or documentation; and/or
localize a result of an implementation of a work step by a terminal capture it, label it with respect to formation and origin and/or store it in the graph database.

4. The research and development system of claim 1, wherein the research and development system comprises a data acquisition unit configured to capture
information on the type, scope and/or time of availability and/or non-availability of a terminal, and/or
information on technical, administrative, legal, contractual and/or other conditions of availability of a terminal and on the status of fulfillment of the conditions of availability
and/or to store it in the graph database.

5. The research and development system of claim 1, wherein the research and development system comprises an interactive human-machine interface configured to
display the results of a work step and/or of the work steps of a workflow graphically,
display a workflow, a work step, the availability of a terminal for performing a work step and/or
receive an input from a human user for selecting a workflow to be performed, a work step to be performed and/or terminal for performing a work step.

6. The research and development system of claim 1, wherein the research and development system comprises at least one of a server, a cloud system, a terminal, an edge computing unit, and a fog computing unit.

7. The research and development system of claim 1, wherein the graph database, the data processing unit, the execution unit, the data acquisition unit, the terminal, the edge computing unit, the fog computing unit and/or the interactive human-machine interface are configured to apply methods of artificial intelligence to provide results in real time.

8. A method for operating a research and development system according to claim 1, the method comprising
at least one of steps a) to k):
a) storing data in a graph database according to a data model that represents a well-defined ontology;
b) unifying, supplementing, and/or enriching data stored in the graph database;
c) identifying statistical and/or causal relationships between data stored in the graph database and/or modeling these relationships using statistical models and/or physico-chemical models;
d) identifying research and development goals included in the stored data and/or generating workflows and/or work steps suitable for achieving the research and development goals;
e) selecting a workflow for achieving a development goal as a function of the development goal and/or selecting a work step from a set of work steps of a selected workflow, in particular as a function of a preceding work step and/or a result of a preceding work step;
f) selecting a terminal for performing a work step, in particular as a function on the type, scope and/or time of the work step to be performed and/or the type, scope, time and/or status of fulfillment of the conditions of availability of the terminal;
g) analyzing a result of a work step by an edge computing unit and/or a fog computing unit and/or forwarding the analysis result as the result of the work step;
h) capturing, labeling with respect to formation and origin and/or storing in the graph database a result of a work step;
i) localizing, capturing and/or storing in the graph database information relevant to a research goal, in particular specialist articles, publications, test series, lectures, comments and/or other relevant records and/or documentation;
j) localizing, capturing and/or storing information in the graph database about the type, scope, time of availability and/or non-availability of a terminal, about technical, administrative, legal, contractual and/or other conditions for the availability of a terminal and/or about the status of fulfillment of the conditions for availability;
k) graphically displaying a result of a work step, several work steps of a workflow, a workflow, a work step and/or the availability of a terminal for performing a work step, and/or
receiving a selection from a human user of a workflow or work step to be performed and/or terminal for performing a work step.

9. The method of claim 8, wherein at least one of steps a)-k) is executed using methods of artificial intelligence.

10. The method of claim 9, wherein the at least one step executed using methods of artificial intelligence is executed in real time.

11. The research and development system of claim 2, wherein the terminal is selected as a function of at least one of (i) the type, scope and/or time of the work step to be performed and (ii) the type, scope, the time and/or the status of fulfillment of the conditions of availability of the terminal.

12. A method for operating a research and development system, the method comprising
a) storing data in a graph database according to a data model that represents a well-defined ontology;
b) unifying, supplementing, and/or enriching data stored in the graph database;
c) identifying statistical and/or causal relationships between data stored in the graph database and/or modeling these relationships using statistical models and/or physico-chemical models;
d) identifying research and development goals included in the stored data and/or generating workflows and/or work steps suitable for achieving the research and development goals;
e) selecting a workflow for achieving a development goal as a function of the development goal and/or selecting a work step from a set of work steps of a selected workflow, in particular as a function of a preceding work step and/or a result of a preceding work step;
f) selecting a terminal for performing a work step, in particular as a function on the type, scope and/or time of the work step to be performed and/or the type, scope, time and/or status of fulfillment of the conditions of availability of the terminal;
g) analyzing a result of a work step by an edge computing unit and/or a fog computing unit and/or forwarding the analysis result as the result of the work step;
h) capturing, labeling with respect to formation and origin and/or storing in the graph database a result of a work step;
i) localizing, capturing and/or storing in the graph database information relevant to a research goal, in particular specialist articles, publications, test series, lectures, comments and/or other relevant records and/or documentation;
j) localizing, capturing and/or storing information in the graph database about the type, scope, time of availability and/or non-availability of a terminal, about technical, administrative, legal, contractual and/or other conditions for the availability of a terminal and/or about the status of fulfillment of the conditions for availability;
k) graphically displaying a result of a work step, several work steps of a workflow, a workflow, a work step and/or the availability of a terminal for performing a work step, and
l) receiving a selection from a human user of a workflow or work step to be performed and/or terminal for performing a work step.
